(19) United States
(12) Patent Application Publication
(10) Pub. No.: US 2010/0250318 A1
(43) Pub. Date: Sep. 30, 2010

(54) Apparatus, Methods and Articles of Manufacture for Addressing Performance Problems within an Organization via Training

(76) Inventors: Laura Paramoure, Raleigh, NC (US); Richard D. Michelli, Raleigh, NC (US)

Correspondence Address: MYERS BIGEL SIBLEY & SAJOVEC, PO BOX 37428, RALEIGH, NC, 27627, US

(21) Appl. No.: 12/730,591

(22) Filed: Mar. 24, 2010

Related U.S. Application Data
(60) Provisional application No. 61/163,285, filed on Mar. 25, 2009.

(51) Int. Cl. G06Q 10/00; G06Q 99/00

(52) U.S. Cl. 705/8; 705/7; 705/11; 705/326

(57) ABSTRACT

Apparatus, methods and articles of manufacture are provided to address performance gaps within an organization. Initially, a gap between actual work performance and expected work performance by a group of one or more persons within an organization is identified. Knowledge and/or skills required to reduce the performance gap are identified and a training program for supplying the group with the identified knowledge and/or skills is selected. A pre-test is administered to the group on a date prior to the training date, and a post-test is administered to the group on a date after training has occurred. An identified performance metric is measured before and after training to determine if the group has changed its behavior to an acceptable degree within the organization. The cost associated with administering the training to the group is determined, and a return on investment value may be calculated.

### RELATED APPLICATIONS

This application claims the benefit of and priority to U.S. Provisional Patent Application No. 61/163,285 filed Mar. 25, 2009, the disclosure of which is incorporated herein by reference as if set forth in its entirety.

### RESERVATION OF COPYRIGHT

A portion of the disclosure of this patent document contains material to which a claim of copyright protection is made. The copyright owner has no objection to the facsimile reproduction by anyone of the patent document or the patent disclosure, as it appears in the Patent and Trademark Office patent file or records, but reserves all other rights whatsoever.

### FIELD OF THE INVENTION

The present invention relates generally to training and, more particularly, to apparatus, methods and articles of manufacture for facilitating training.

### BACKGROUND OF THE INVENTION

Historically, educators, trainers and human resource professionals have struggled to produce evidence that supports the productivity of training initiatives. They have often been discouraged by the lack of simple and effective methods of assessment. Particularly in business, senior management is increasingly requesting evidence that its investment in training is contributing to the success of the organization. Providing viable evidence of training's impact to an organization may be essential for ensuring continued support from senior management. For training vendors, providing viable evidence of the impact of training may be required for customer satisfaction and continued opportunity to provide training solutions.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

According to some embodiments of the present invention, methods, apparatus, and articles of manufacture which facilitate user compliance with established best practices in training evaluation are provided. Embodiments of the present invention provide educators, trainers, human resource professionals, and other business professionals a method for capturing learning's impact on business process, utilizing a decision based procedure to ensure effective knowledge transfer and business metric impact in three main areas 1) within the learning environment, 2) on-the-job and 3) within organizational metrics.

Embodiments of the present invention facilitate the implementation of the practice of training evaluation by helping educators, trainers, human resource professionals, and other business professionals to complete the necessary steps, to enable measurement of trainings impact at all levels.

According to some embodiments of the present invention, apparatus, methods and articles of manufacture that are configured to address performance problems within an organization are provided. Initially, a gap between actual work performance and expected work performance by a group of one or more persons within an organization is identified, and is referred to as a performance gap. Knowledge and/or skills required to reduce the performance gap are then identified and a training program for supplying the group with the identified knowledge and/or skills is selected. The selection of a training program may include selecting a training program that already exists, creating a new training program, or modifying an existing training program. Included with the selection of a training program is the identification or creation of a “mastery test” that is designed to help determine if a sufficient learning opportunity exists prior to administering a selected training program.

A training date for the group to receive the selected training program is assigned and a measurable performance metric that can reflect behavior change of the group with respect to work performance is identified. A behavior change date after the training date is assigned on which to measure the performance metric. The behavior change date is selected based on historical data associated with transfer of similar knowledge and/or skills.

In some embodiments, the performance metric is a metric that is currently monitored by the organization. For example, the performance metric may be monitored by an accounting system, security system, quality control system, etc., within the organization. In some embodiments, a determination is made whether the identified performance gap can be reduced via training prior to selecting a training program.

A benchmark date prior to the training date is assigned to the group on which to measure the performance metric for the group, and the performance metric for the group is measured on the benchmark date. A first test is then administered to the group on a date prior to the training date (this can be done on the date the training starts; it is just done prior to training taking place). This first or pre-test (also referred to as the mastery test) is configured to measure knowledge and/or skills of the group. If it is determined that a sufficient learning opportunity is available, the selected training program is administered to the group on the selected training date. If it is determined that a sufficient learning opportunity does not exist because the knowledge of the training content is already possessed by the evaluation group, or for other reasons, operations terminate and the training requirements are revisited.

A second test or post-test is then administered to the group on a date after the training date and before the behavior change date. The post-test is identical to the pre-test and a comparison of the scores by the group on the pre-test and post-test provides an indication of whether an acceptable level of learning occurred as a result of the training program. If the difference between the scores (e.g., an average score if multiple members of the group) is less than a predetermined amount, the training program is modified and then administered to the group. In some embodiments of the present invention, a visual representation of a comparison of the scores of the pre-test and post-test is displayed.

On the previously selected behavior change date, the identified performance metric is measured for the group and then compared with the performance metric as measured on the benchmark date to determine if the group has changed its behavior to an acceptable degree within the organization. If the performance metric measurement indicates that the level of behavior change is not acceptable, reasons for the failure are sought. If the performance metric measurement indicates that the level of behavior change is acceptable, the cost associated with administering the training program to the group is determined, and a return on investment value is calculated.

According to some embodiments of the present invention, a second or control group of one or more persons in the organization that are not in the first group is identified. Members of the control group are homogeneous to the first group (i.e., have similar skill levels, similar job responsibilities within the organization, etc., to the first group). The identified performance metric is measured for both groups on the benchmark date and the behavior change date and the results are compared to quantify an amount the performance gap has been reduced. In some embodiments, a visual representation of a comparison of the performance metric measured on the behavior change date and the performance metric measured on the benchmark date.

According to other embodiments of the present invention, apparatus, methods and articles of manufacture for addressing performance problems within an organization include designing a training program to address an identified gap between actual work performance and expected work performance by a group of one or more persons within an organization; comparing an average score obtained by the group on a first test administered to the group before the group has attended the training program with an average score obtained by the group on a second test administered to the group after the group has attended the training program, wherein the first and second tests are identical and are configured to measure knowledge and/or skills of the group related to expected work performance; and in response to determining that a difference between the two average scores is less than a predetermined amount, modifying the training program. A visual representation of a comparison of the average scores of the first and second tests may be displayed.

According to other embodiments of the present invention, apparatus, methods and articles of manufacture for addressing performance problems within an organization include designing a training program to address an identified gap between actual work performance and expected work performance by a group of one or more persons within an organization; measuring a performance metric that reflects a change in behavior of the group with respect to the performance gap after the group has attended the training program; determining the cost associated with administering the training program to the group; and determining a return on investment value of the training program. A second group of one or more persons in the organization that are not in the first group, but that are homogeneous to the first group, may be identified. The performance metric is measured with respect to the second group and compared with the performance metric measured for the first group to quantify an amount the performance gap has been reduced. A visual representation of a comparison of the performance metric measured for the first and second groups may be displayed.

According to some embodiments of the present invention, a database is created that provides information to create future training strategies. Some benefits include historical reference on the types of training to most impact job performance, the time required for training's impact to organizational impact measures and the type of training to most impact particular metrics in the organization.

Embodiments of the present invention facilitate thorough and accurate steps to provide linkage between learning initiatives, job behavior and organizational metrics within an identified training program. In addition, embodiments of the present invention impose a decision based procedure to ensure effectiveness of each step to an organization.

It is noted that aspects of the invention described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail below.

### BRIEF DESCRIPTION OF THE DRAWINGS

The accompanying drawings, which form a part of the specification, illustrate various embodiments of the present invention. The drawings and description together serve to fully explain embodiments of the present invention.

FIGS. 1A-1B are flow charts illustrating operations for addressing performance problems in an organization via training, according to some embodiments of the present invention.

FIGS. 2-10 are graphical user interfaces utilized to implement the various operations illustrated in FIGS. 1A-1B, according to some embodiments of the present invention.

FIG. 11 is a block diagram that illustrates details of an exemplary processor and memory that may be used for addressing performance problems in an organization via training, according to some embodiments of the present invention.

### DETAILED DESCRIPTION

The present invention will now be described more fully hereinafter with reference to the accompanying figures, in which embodiments of the invention are shown. This invention may, however, be embodied in many different forms and should not be construed as limited to the embodiments set forth herein. Like numbers refer to like elements throughout. The sequence of operations (or steps) is not limited to the order presented in the figures and/or claims unless specifically indicated otherwise. Features described with respect to one figure or embodiment can be associated with another embodiment or figure although not specifically described or shown as such.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

It will be understood that although the terms first and second are used herein to describe various features/elements, these features/elements should not be limited by these terms. These terms are only used to distinguish one feature/element from another feature/element. Thus, a first feature/element discussed below could be termed a second feature/element, and similarly, a second feature/element discussed below could be termed a first feature/element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The term “control group”, as used herein, refers to a group of persons from an organization similar to an evaluation group that will not receive training, and that serve as a baseline for evaluating the effectiveness of a training program.

The term “evaluation group”, as used herein, refers to a group of persons from an organization having a knowledge/skill deficiency that is causing a performance gap within the organization, and that receive training to overcome the knowledge/skill deficiency.

The term “mastery test”, as used herein, refers to a test developed to capture proficiency of specific knowledge and skills required for closing a performance gap.

The term “performance gap”, as used herein, refers to a discrepancy between the actual performance of a job or task and an expected performance of the job or task by a person or group of persons within an organization. A performance gap can be reduced with a change in knowledge, skill, or attitude of the person(s) in the group.

The term “pre-test”, as used herein, refers to a test administered to an evaluation group before training in order to establish a baseline and to help understand the opportunity for learning.

The term “post-test”, as used herein, refers to a test administered to an evaluation group directly after training in order to establish whether learning occurred as a result of training. The post-test uses the same test questions and skill measurements as the pre-test.

The terms “training program” and “training project”, as used herein, are interchangeable and refer to training provided to members of an evaluation group in order to reduce an identified performance gap.

The term “training transfer”, as used herein, refers to a determination of whether an evaluation group has had the opportunity to use newly obtained knowledge and skills in the organization.

The term “wizard”, as used herein, refers to a computer utility designed to simplify the execution of lengthy or complicated tasks. As known to those of skill in the art, a wizard is essentially a programmatic method of providing guidance to an operator via one or more graphical user interfaces (GUIs).

The present invention may be embodied as apparatus, methods, and/or computer program products (articles of manufacture) for carrying out various operations for correcting performance problems within an organization. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), and a portable compact disc read-only memory (CD-ROM).

The present invention is described herein with reference to GUIs, flowchart illustrations and block diagram illustrations of methods, apparatus, and articles of manufacture for implementing various operations for correcting performance problems within an organization, according to embodiments of the present invention. It will be understood that each block of the flowchart and/or block diagram illustrations, and combinations of blocks in the flowchart and/or block diagram illustrations, may be implemented by computer program instructions and/or hardware operations. These computer program instructions are provided to a processor, or other programmable data processing apparatus to produce a machine, such that the instructions, which execute via the processor and create means for implementing the functions specified in the GUIs, flowcharts and block diagram blocks.

These computer program instructions may also be stored in a computer usable or computer-readable memory such that the instructions produce an article of manufacture including instructions that implement the functions specified in the GUIs, flowcharts and block diagram blocks.

The computer program instructions may also be loaded onto a controller or other programmable data processing apparatus to cause a series of operational steps to be performed on the controller or other programmable apparatus to produce a computer implemented process such that the instructions that execute on the controller or other programmable apparatus provide steps for implementing the functions specified in the GUIs, flowcharts, and block diagram blocks.

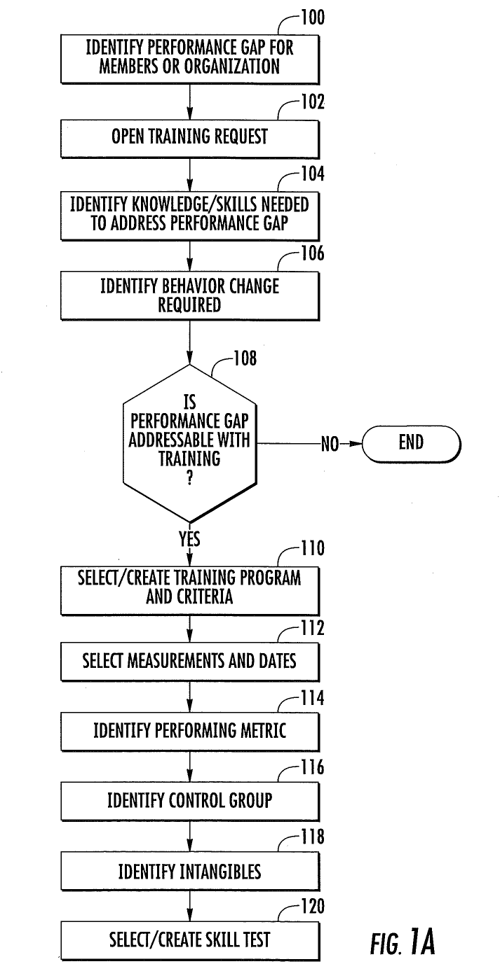

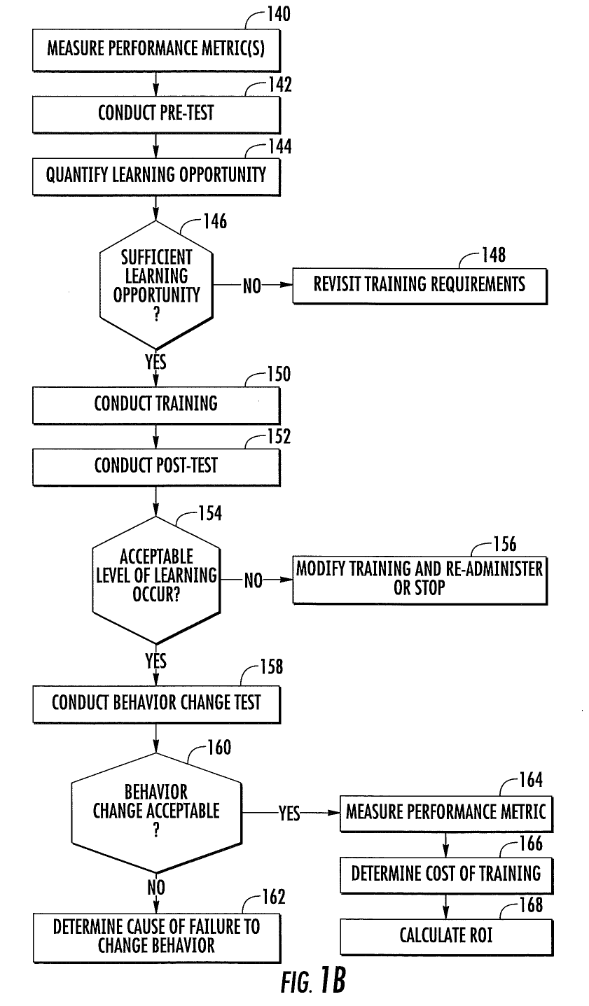

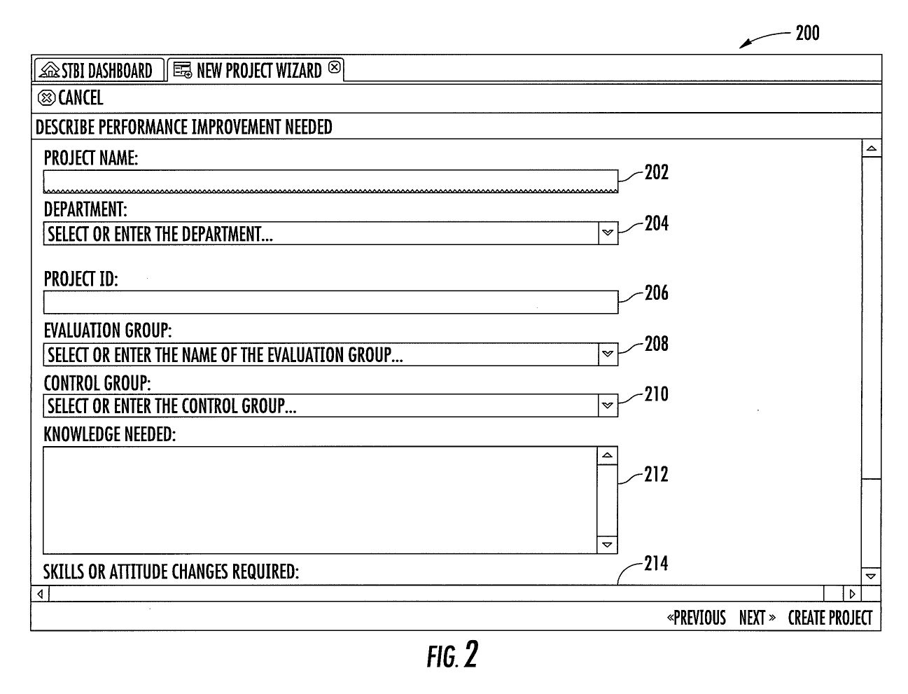

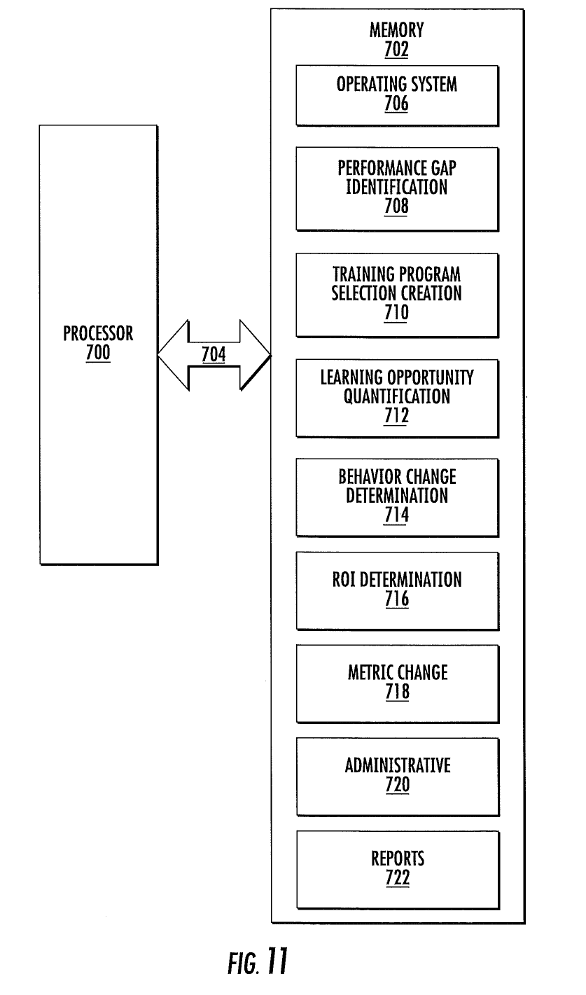

FIGS. 1A-1B represent operations performed by and/or using a computer apparatus, such as that represented by processor 700 and memory 702 illustrated in FIG. 11. References to an apparatus throughout this specification are intended to indicate a computer apparatus such as that illustrated in FIG. 11. Referring to FIG. 1A, initially a performance gap within an organization is identified (Block 100). In some embodiments, a person within the organization, such as a business manager, may identify a performance gap. In other embodiments, a performance gap is identified by computer systems/programs monitoring activities within an organization (e.g., quality control systems, accounting systems, security systems, etc.). As defined herein, a performance gap is a discrepancy between the actual performance of a job or task and an expected performance of the job or task by a person or group of persons within an organization. A training request is then opened via a computing device (Block 102), wherein the performance gap is classified and recorded. The performance gap classification may be unique or pre-defined, in which case it may be selected from a drop down list in a GUI. The classification may also include more general sub-classification, such as employee level, job requirements, etc. This sub-classification is not necessary for the process but serves to improve the historical data and reference capability for future training projects. Additional identification data, such as company name, department, etc. is recorded at this point to uniquely identify the training project.

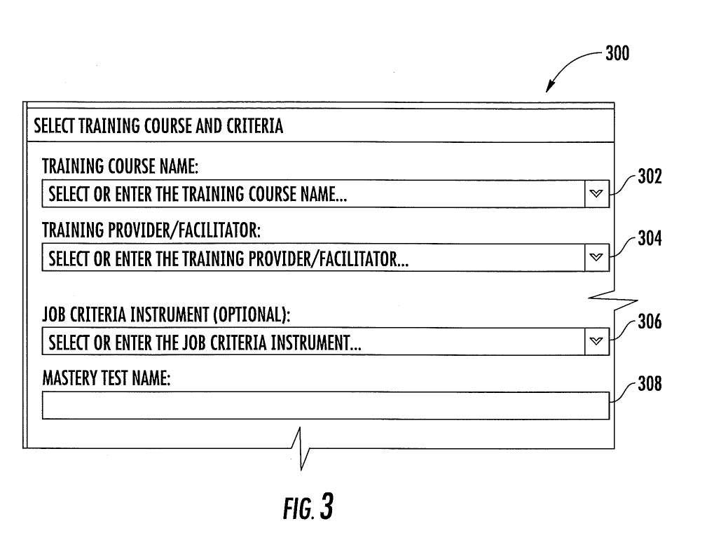

FIG. 2 illustrates an exemplary GUI 200 for opening a training request and entering information about an identified performance gap within an organization. In the illustrated GUI 200, various entry fields are displayed within which a user can enter information to be stored, for example, within a database. For example, in field 202, the user enters a training project name; in field 204, the user enters the name of the department of the organization in which the person or persons exhibiting a performance gap are located (or selects the name of the department from a drop down list); in field 206, the user enters a training project identification. In field 208, the user enters the name of an evaluation group or selects the name of the evaluation group from a drop down list. The evaluation group is the person or persons that are exhibiting a performance gap and that will receive training to try and reduce the performance gap. In field 210, the user enters the name of a control group or selects the name of the control group from a drop down list. The entry of a control group may be optional and defines a group, similar to the evaluation group, that will not receive training and that will be used to provide a baseline for training effectiveness. Typically, members of the control group have similar job descriptions, duties and responsibilities within the organization as members of the evaluation group.

Still referring to FIG. 2, in field 212, the user describes the knowledge/skills needed by a member of the evaluation group. Information in this field is provided to capture specific knowledge and/or skills needed to fill the identified performance gap. Such information includes key information the evaluation group should learn from the training in order to be successful in closing the performance gap. In field 214, the user enters information about skills and/or attitude changes required by the person or persons in the evaluation group. This information is provided to capture specific skills the evaluation group is required to master in order to eliminate the performance gap. Any specific measurements used on the job by the evaluation group members to determine performance level should be considered when determining skill or attitude requirements.

As an example of a performance gap by a group within an organization, a call center manager notices that the Customer Report Forms (in an EXCEL® spreadsheet format) are not being completed in a timely manner. The department is identified in the GUI 200 as the call center and the performance gap is classified as a productivity issue. The process continues with the identification of the individual(s) in the evaluation group (i.e., those in need of performance improvement). The evaluation group should be readily identifiable and sufficiently isolated such that training can be effectively administered and measured. In the call center example, the evaluation group would be entered in the field 208 (or selected from pull down box) of GUI 200 as “all first shift call center operators.”

Referring back to FIG. 1A, after the evaluation group is identified (Block 100) and a training request is opened (Block 102), knowledge/skills needed to address performance gap are identified (Block 104). In addition, behavior change(s) required are identified (Block 106). A determination is then made if the identified performance gap is addressable with training (Block 108). The performance gap is considered to be addressable via training if the performance gap is due to a knowledge/skill or attitude deficiency of members of the evaluation group. However, if the performance gap is due to some other factor (e.g. environmental factors, etc.), training may not be capable of addressing the performance gap. This determination may be based on experience, historical data (similar performance gaps that have previously existed), consultation with a training expert, etc. In the call center example, it may be determined that the call center operators are not knowledgeable enough on the use of EXCEL® spreadsheets to complete various forms efficiently, and that training in the use of EXCEL® spreadsheets will address the performance gap.

Once the performance gap has been identified and is believed to be addressable with training (Block 108), the most appropriate training program for addressing the performance gap is selected/created (Block 110). In order to select/create the training program most appropriate to administer the specific knowledge, skills or attitude needed to fill the performance gap, the specific knowledge and skills needed along with the specific behavior change required is considered. Additional scrutiny is paid to proper identification of the knowledge/skill or attitude deficiency to be addressed with the training. This may be done by reviewing current work tasks and subsequent performance, reviewing specific tasks required to improve work performance, and/or with consultation with a training expert, to determine the specific knowledge/skill or attitude that is deficient. The specific knowledge/skill or attitude is recorded within a GUI and may be unique or pre-defined, in which case it may be selected from a drop down list in a GUI. Once specific knowledge and skills required to fill a performance gap is determined, the specific job performance change required to fill the gap is identified. The combination of the knowledge and skill requirements along with the specific job performance change required provide the information necessary to select/create a specific training program (Block 110).

In the call center example, a determination is made that the call center operators need to understand (i.e., have knowledge) how to calculate EXCEL® spreadsheet formulas, reformat EXCEL® spreadsheet cells, and populate EXCEL® spreadsheet cells. The behavior change required is to complete all of the “open” fields in the “Customer Order Forms.” The combination of the knowledge/skill requirements and behavior change requirements allow an appropriate training program to be selected (Block 110).

The selection of the appropriate training program (Block 110) may be facilitated by a wizard type program that asks specific questions and arrives at a recommended training solution. Regardless, the training program is selected with consideration of specific information, tasks, and behavior change necessary to improve job performance.

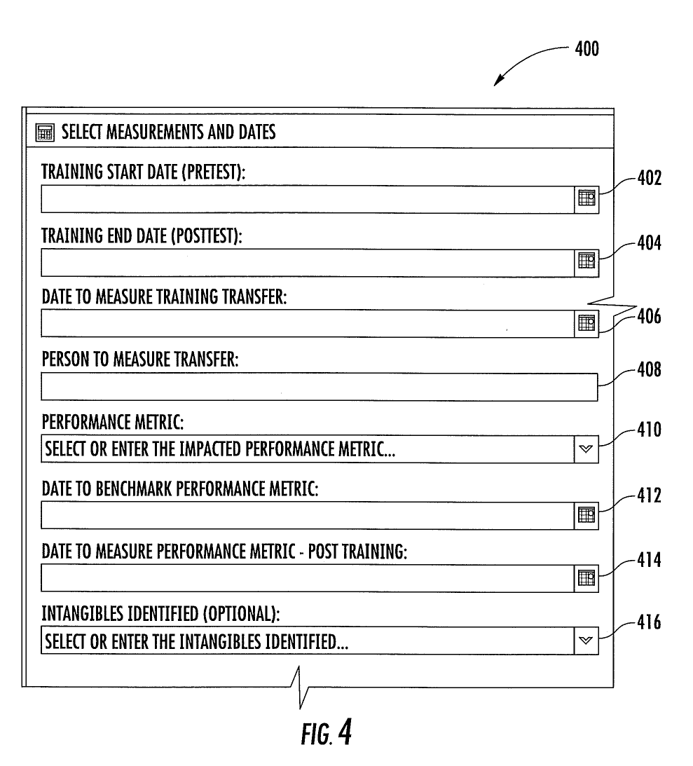

FIG. 3 illustrates an exemplary GUI 300 that facilitates selection of a training program and criteria associated therewith. In the illustrated GUI 300, various entry fields are displayed within which a user can enter information. For example, in field 302, the user enters the name of a training program or selects the name from a drop down box. In field 304, the user enters the name of a training provider/facilitator/vendor that will provide the training, or selects the name of a training provider/facilitator/vendor from a pull down box. In field 306, the user may optionally enter a job criteria instrument or selects one from a drop down box. A job criteria instrument is an instrument used to perform a function by a member of the evaluation group on the job and indicates the requirement for success. For example, an instrument may be a checklist, a form, etc. In field 308, the user enters the name of a mastery test. A mastery test is the instrument used to measure a person's achievement of the knowledge, skill, or attitude objectives obtained from a training program. A mastery test may be customized to include identified job criteria.

Referring back to FIG. 1A, after a training program has been selected (Block 110), the user selects and enters various measurement criteria and logistical information such as dates (Block 112). In some embodiments, one or more dates and measurement criteria may be automatically determined by a computer apparatus (e.g., the computer apparatus illustrated in FIG. 11). The logistical information includes the training date, training provider, the date to complete the on the job behavior change measurement and the individual selected to measure the on the job behavior change. The date selected to measure the on the job behavior change should allow sufficient time for the behavior change to be applied to the job. The time it takes for the behavior to be applied to the job may also be determined by a search of historical data reflecting the same skills transfer.

FIG. 4 illustrates an exemplary GUI 400 for selecting various measurements and dates. In the illustrated GUI 400, various entry fields are displayed within which a user can enter information. For example, in field 402, the user enters a training start date for a pre-test. The pre-test is designed to show the skill level of a person prior to the training program. A calendar function that allows the user to select a date may be associated with the field 402. In field 404, the user enters a training end date; that is, the final date of training upon which a post-test is given. A calendar function that allows the user to select a date may be associated with the field 404.

In field 406, the user enters the date to measure training transfer. This date is the date that the mastery test is administered to a person in the evaluation group. This date is selected such that the person has sufficient classroom learning and such that the person has had sufficient time to transfer the training knowledge adequately to the job. For example, a date two weeks after training has ended may be selected. However, date selection may be up to the user and embodiments of the present invention are not limited to any particular time frame within which to conduct the mastery test. A calendar function that allows the user to select a date may be associated with the field 406.

In field 408, an individual is identified who will administer the mastery test to the person(s) in the evaluation group. In field 410, the user enters a performance metric associated with the identified performance gap or selects a performance metric from a dropdown box. The performance metric is identified in field 410 without indication of a desired result. For example, “order entry errors” should not be stated as a “reduction or increase in order entry errors.”

Referring back to FIG. 1A, at this point a specific performance metric to be impacted by the training program is identified (Block 114). The identified performance metric may be a currently measured metric that is consistently monitored and directly impacted by the anticipated behavior change resulting from the training program. In the call center example, “orders processed” is an exemplary performance metric that is consistently measured and that is used to comprehend the number of customer orders processed. In conjunction with identifying a performance metric, a date for the benchmark of the performance metric and a date for measuring the performance metric post-training is selected. The benchmark date is a date prior to the training, ideally as close to the start date of training as practical, in order to reflect a true value prior to training. The date selected to measure the metric post-training is dependent on the time necessary for the behavior change to impact the metric. In the call center example, the measurement of the metric after training has occurred is selected to be one month from the completion of the training program. This date is selected because it is believed to take one month for the trainees to become comfortable with applying their new EXCEL® spreadsheet skills within the organization.

In the illustrated embodiment of FIG. 4, the user uses GUI 400 to enter various date information associated with the identified performance metric. For example, in field 412, the user enters a date to benchmark the performance metric. This is the date that the performance metric is to be recorded prior to training. A calendar function that allows the user to select a date may be associated with the field 412. In field 414, the user enters a date to measure the performance metric-post training (i.e., after the training has taken place). This is the date that the performance metric is recorded after training transfer is measured. The date selected should allow sufficient time for the changes to be reflected in the performance metric. For example, a date two weeks to three weeks after training transfer may be selected. However, date selection may be up to the user and embodiments of the present invention are not limited to any particular time frame within which to conduct the mastery test. A calendar function that allows the user to select a date may be associated with the field 414.

Referring back to FIG. 1A, to add rigor to the isolation of training to the impact to the organization, a control group can be identified (Block 116). A control group is a group of individuals that is homogeneous to the evaluation group. A group of individuals may be considered to be homogeneous if they have similar skill levels, similar job responsibilities and similar expectations in on the job behavior requirements to the evaluation group. However, the control group does not receive training. Measurements for the control group will be collected using the same dates as selected for the training date in order to provide a direct comparison of change.

Beyond direct changes in trainee skills, job behaviors, and business metrics, training often presents intangible benefits. Intangible benefits such as employee morale, employee satisfaction, employee development or organizational development are often realized from the completion of training programs but are difficult to quantify. In the call center example, the call center training on EXCEL® spreadsheets is expected to have an intangible benefit of improving employee morale. It is expected that by allowing the call center employees to participate in training they will gain self-esteem from improving their skill and in turn employee morale will improve. Identifying the intangible benefits expected from a training intervention supports reflecting true and complete impact to the organization. Intangible impacts to the organization are identified and associated with a particular training program (Block 118). In the illustrated embodiment, the user uses GUI 400 to enter various intangibles information. For example, in field 416, the user optionally enters information associated with identified intangibles or selects such information from a drop down box. This information identifies changes to the organization not currently represented by a metric. For example, employee morale, job satisfaction, employee loyalty, etc., are exemplary intangibles.

Referring back to FIG. 1A, at this point a skill test is selected/created that will monitor the effectiveness of the training program (Block 120). This skill test is intended to measure the trainees' ability to perform a skill to the required level. The test may include both a measure of specific knowledge and skill gain as well as on the job performance requirements. In the call center example, in addition to knowledge and skill objectives, the test may include a sample customer order form used in the completion of the trainee's job. Along with other knowledge and skill measurements, the trainee's ability to properly complete the form would be scored.

According to some embodiments of the present invention, to assist in the development of functional measurable objectives directly related to knowledge/skill evaluation techniques, a wizard may be utilized. The wizard supports selection of appropriate verbs to enable construction of objectives and provides corresponding measurement techniques for creating effective mastery tests.

The skill test, measuring both knowledge/skill objectives and specific job requirement competencies, will be administered at three distinct times during the process. The test is first administered just prior to instruction during the beginning of a training program. This provides a quantitative measurement of the trainees pre-training abilities with regard to the specific skill and serves as a “before” measure for training. The second administration of the test is immediately after instruction at the end of a training program. This measures the transfer of knowledge to members of the evaluation group during the training program.

To assist in calculating results of a mastery test, a wizard may be utilized to enable recording of a participant's scores and conversion into course averages. Process decisions will be made later based on the outcome of this test. The final administration of the test is at the pre-determined on the job behavior change measurement date, which was selected to allow sufficient time for the training to effectively transfer to the job. Once again, process decisions will be made later based on the outcome of this test. Finally, pass/fail criteria are determined. The pass/fail criterion is typically a score which indicates the trainee sufficiently understands the material. In our example the pass threshold is 80%.

Referring now to FIG. 1B, steps performed during a training program execution phase, according to some embodiments of the present invention, are illustrated. Initially, the business metric(s) of interest is measured for both the evaluation group (and the control group, if utilized) on the designated date (Block 140). This data is recorded for use in future calculations, and may be entered into the computer apparatus.

With the baseline metric level(s) measured and recorded (Block 140), a selected pre-test is administered (Block 142) in order to establish a baseline knowledge level of the evaluation group. The pre-test results are then entered into the computer apparatus. The pre-test results are compared to the established pass/fail criteria, in order to quantify a learning opportunity (Block 144). A determination is made at this point if a sufficient learning opportunity is available (Block 146). If it is determined that a sufficient learning opportunity is available, the selected training program is conducted according to the stated objectives and outlined design (Block 150). If it is determined that a sufficient learning opportunity does not exist because the knowledge of the training content is already possessed by the evaluation group, or for other reasons, operations terminate and the training requirements are revisited (Block 148), for example, to determine if the behavior change sought is due to a knowledge/skill/attitude deficiency or if the training program selected is the appropriate program for the evaluation group. Upon completion of the training program, the pre-test is re-administered, now called the post-test, to measure changes in knowledge/skill/attitude attained by the training program. The post-test results are recorded and entered into the computer apparatus.

At this point, the pre-test and post-test scores are reviewed and analyzed to determine if an acceptable level of learning occurred as a result of the training program (Block 154). Learning is measured by an increase in the score from the pre-test to the post-test. The comparison of the two scores shows the effectiveness of the training program. In addition, the post-test score is compared against the pre-established pass/fail criteria to determine if an acceptable level of learning has occurred. If learning did not occur at an acceptable level, the training program design and/or implementation may be analyzed to determine methods of improvement to the training program. If the training can be modified such that learning can occur at an acceptable level, the training program is modified and is re-administered (Block 156). However, if the training cannot be modified, the process may be halted.

If the training design and implementation has been deemed effective at accomplishing learning of the material presented, the evaluation group returns to work within the organization. At the pre-determined date, a behavior change test is given to the evaluation group in order to determine if members of the evaluation group are able to retain the knowledge/skill obtained in class and apply the knowledge and skill to the organization environment (Block 158). The results of the behavior change test are recorded, and entered into the computer apparatus.

The post test results and the behavior change test results are compared to determine if the knowledge/skill gained in training has been transferred to work within the organization at an acceptable level (Block 160). In other words, a determination is made whether the behavior of the evaluation group within the organization changed to an acceptable degree or if the knowledge/skill gain from training was retained. If the behavior change is not acceptable, as indicated by the comparison of what the evaluation group knew/did at the end of training and what they knew/did at work in the organization, then the cause of the failure to change behavior is determined (Block 162). For example, environmental factors within the organization may exist that are a deterrent to the new knowledge/skill being applied to the job.

If the knowledge has been retained and applied to work within the organization, then it can be concluded that training was sufficient to provide behavior change on the job. The next step involves measuring the changes to the job transfer to a change in a predetermined business metric (Block 164). At the pre-determined date (Post-Training business metric date), the business metric is again measured for the evaluation group and the control group. The measurement is collected for future evaluation and entered into the computer apparatus.

The next step is to determine the costs of the training program so that the value of the changes to the organization can be compared to the costs of the training program (Block 166). The costs of the training program may include costs for program development, materials, and facilitation or any other direct costs identified by the training manager. In the call center example, the cost of providing EXCEL® spreadsheet level II to the call center personnel on shift one was, $12,000 including development, facilitation and materials costs. The percentage change in the orders processed was 33%. A return on investment (ROI) is then calculated using the cost of the training and the amount of change in the business metric (i.e., the difference between the post-training metric value and the pre-training metric value (Block 168).

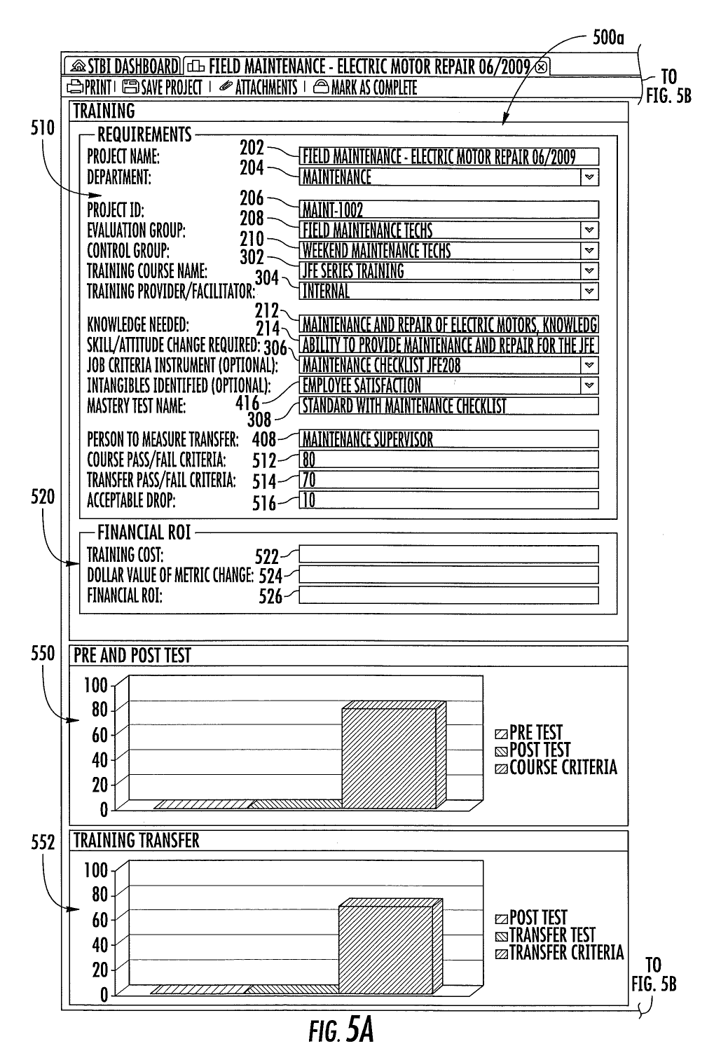

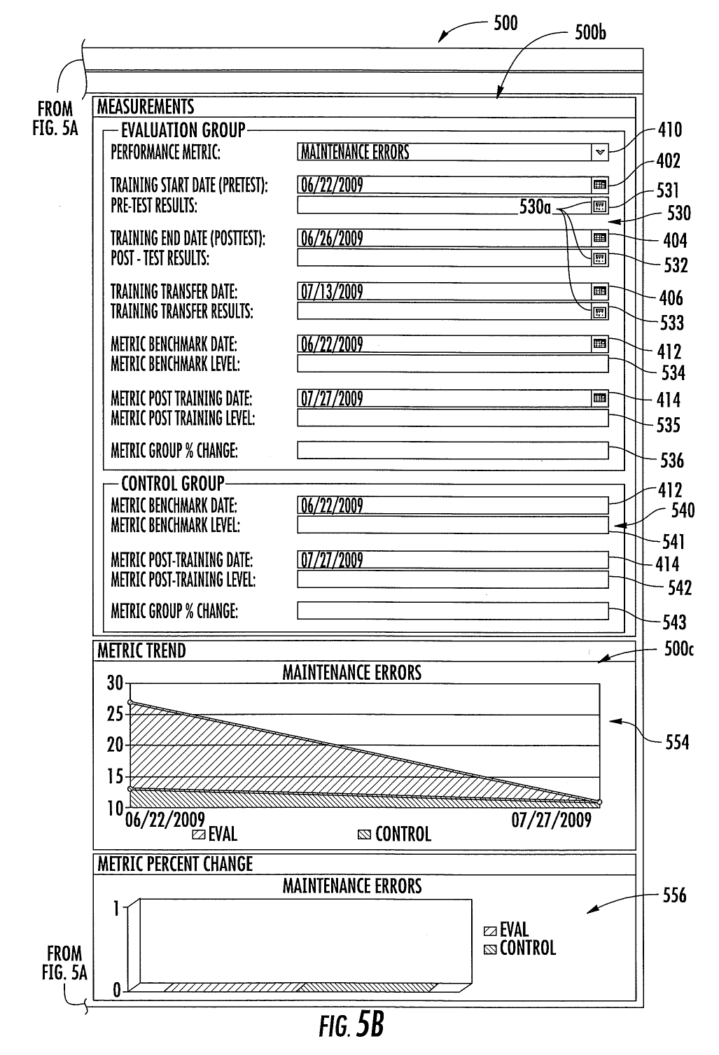

Referring to FIGS. 5A-5B, a summary of a particular training project is illustrated in GUI 500. The data provided in GUI 500 is organized into three sections 500a, 500b and 500c. GUI section 500a is located on the left side of GUI 500 and contains a sub-section 510 for training project requirements information and a sub-section 520 for financial return on investment (ROI) information. The information previously entered by a user in GUIs 200, 300 and 400 is summarized in the requirements sub-section 510. Information in the various displayed fields may be edited within the GUI 500.

GUI section 500a also displays the pass/fail levels set by an organization and represented by data entry fields 512, 514 and 516. Values displayed within fields 512, 514 and 516 are organization-wide passing thresholds and are not editable. Only a system administrator can change the values displayed in these fields. In field 512, course pass/fail criteria is displayed. The displayed value is the passing threshold for the training program and is measured by the post-test. This value is displayed in the pre- and post-test graph (described below) as “Course Pass.” Failure to achieve this level indicates that learning did not occur at a sufficient level during the training event, and the training process should be reevaluated (Block 156, FIG. 1B). In field 514, training transfer pass/fail criteria is displayed. The displayed value is the passing threshold for the transfer of learning to performance on-the-job. This value is displayed in the training transfer graph as “transfer pass.” Failure to achieve this level indicates classroom learning did not transfer to on-the-job performance at a sufficient level, and the training process should be reevaluated. In field 516, acceptable drop information is displayed. The displayed value is the acceptable tolerance for test score decrease between the classroom and on-the-job, specifically between the post-test results and training transfer results. Some decrease in test scores between the post-test and training transfer tests is normal; however, too much may indicate other problem areas that require investigation.

The financial ROI sub-section 520 allows a user to calculate the financial ROI for the training event. In field 522, the user enters the cost of the training program. Exemplary items that may be included in this cost are training materials, facilitators' guide, travel costs, trainee's loss of work time, etc. In field 524, the user enters the dollar value of the performance metric change. This value may be generated by the user and is based on the financial impact of the change in the performance metric as a result of the training event. In field 526, the ROI value is automatically displayed using the values entered into fields 522, 524.

GUI section 500b is located on the right side of GUI 500 and displays scheduled dates for project events and records their associated data. GUI section 500b contains a sub-section 530 for the evaluation group and a sub-section 540 for the control group. The evaluation group subsection 530 contains information specific to the group receiving training. The date information entered in GUI 400 is automatically displayed. Due date indicators and order of dates features are also displayed. Each date has a data field associated with it, located directly beneath the date field. For example, the training start date (pre-test) event date is when the pre-test will be administered and scored. That score data will be entered into the pre-test results field 531 located directly below the date field 402. In the illustrated embodiment, the pre-test value is displayed as 38. Additional fields in sub-section 530 include performance metric 410 and metric group % change 536, which is a calculated value based on the metric benchmark level and the metric post training level.

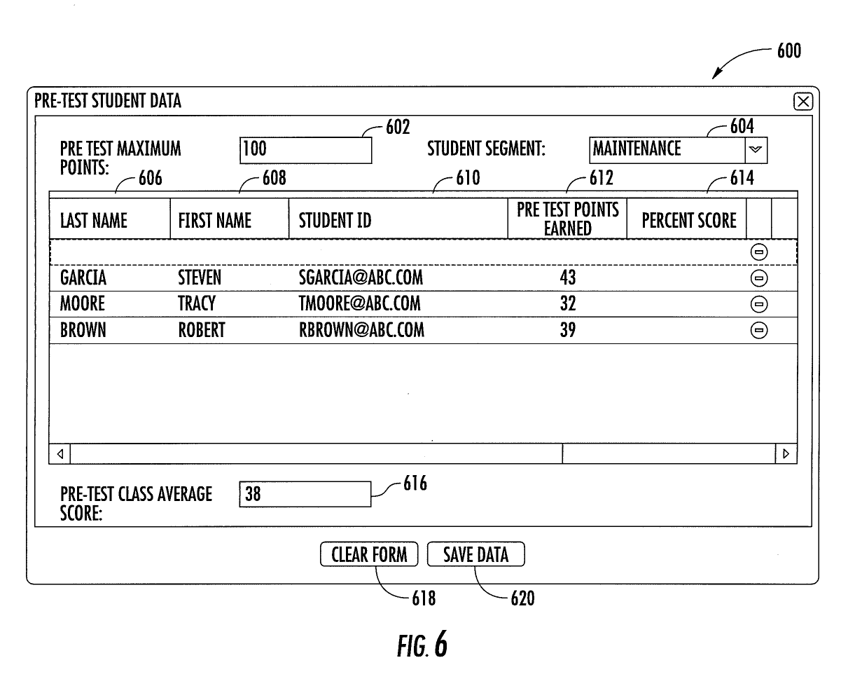

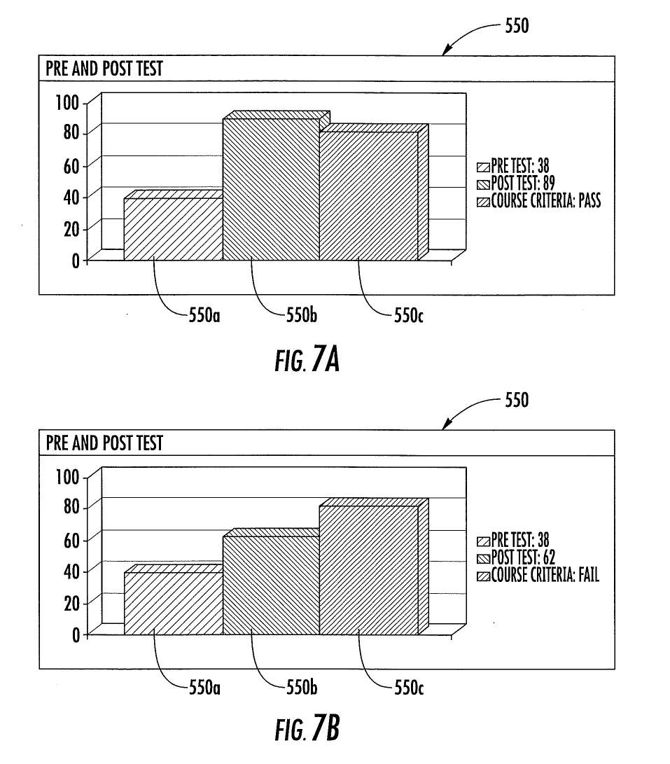

In the pre-test Results field 531, the average pre-test score for the evaluation group is displayed. Test score data is entered via a score entry wizard GUI 600 (FIG. 6), which is accessed by activating the calculator GUI control 530a on the right side of the field 531. The number displayed in the field 531 is the calculated class average score for the pre-test. This value is also displayed in the pre- and post-test graph 550 at the bottom left of the GUI 500. In the post-test results field 532, the average post-test score for the evaluation group is displayed. Test score data is entered via a score entry wizard GUI 600, which is accessible by activating the calculator GUI control 530a on the right side of the field 532. The number displayed in the field 532 is the calculated class average score for the post-test. This value is also displayed in the pre- and post-test graph 550 and the training transfer graph 552 at the bottom left of the illustrated GUI 500.

In the training transfer results field 533, the average training transfer score for the evaluation group is displayed. Test score data is entered via a score entry wizard GUI 600, which is accessible by activating the calculator GUI control 530a on the right side of the field 533. The number displayed in the field 533 is the calculated class average training transfer score. This value is also displayed in the training transfer graph 552 at the bottom left of the GUI 500. In the metric benchmark level field 534, an initial value of the performance metric achieved by the evaluation group is displayed. This is measured before training begins and is displayed also in the metric trend graph 554 at the bottom right of the illustrated GUI 500.

In the metric post-training level field 535, a final value of the performance metric, as achieved by the evaluation group, is displayed. This is measured after the training transfer event and after enough time has passed for the performance metric to reflect changes brought about by training. This value is also displayed in the metric trend graph 554 at the bottom right of the illustrated GUI 500. In the metric group % change field 543, the percent change of the performance metric level for the evaluation group over the course of the training project is displayed. This value is automatically calculated and is also displayed in the Percentage Change graph 556 at the bottom right of the illustrated GUI 500.

FIG. 6 illustrates a Score Entry Wizard GUI 600 that is displayed upon activation of the GUI control 530a in fields 531, 532 and 533 of GUI 500. The score entry wizard GUI 600 provides a fast and convenient method, for listing members of the evaluation group (also referred to as trainees or students), entering test scores, and managing results. The score entry wizard GUI 600 is configured for the specific test from which it was activated. For example, in the illustrated embodiment, the score entry wizard GUI 600 is titled pre-test student data, indicating the GUI 600 was activated by GUI control 530b in the pre-test results field 531 of GUI 500. In the pre-test maximum points field 602, the total number of points available on a particular test is displayed. This value may be changed to suit the particular mastery test being administered. For example, if the test is scored as “x” out of 25, this value will be 25. The student segment field 604 displays a drop down list containing all available student segments within an organization. Student segments are groups defined by an administrator that provide a convenient selection filter for adding students (i.e., persons to be trained) from the organization to a training class.

Student and score information is displayed within fields 606-614. For example, fields 606 and 608 display the last and first names of a student, respectively. This information may be automatically populated upon adding the student to the class. Field 610 displays a unique identification for each student, such as an email address, for example. Field 612 displays test points earned on a particular mastery test. In the illustrated GUI 600, the three students displayed earned 43, 32 and 39 points, respectively, out of a total of 100. The class average field 616 displays the average test score for students in a particular class. In the illustrated GUI 600, the test scores are from a pre-test and the class average field is entitled pre-test class average score, accordingly. GUI controls 618, 620 are provided at the bottom of the illustrated GUI 600. GUI control 618, when activated by a user, clears all student and test score information from the GUI 600. GUI control 620, when activated by a user, saves information in the GUI 600.

Referring back to FIG. 5B, the control group sub-section 540 displays information from the control group performance metric levels. The various date fields display the values from the evaluation group metric benchmark and metric post training dates. For example, the metric benchmark date field 412 displays the date that a benchmark pre-test is administered to an evaluation group, and the metric post-training date field 414 displays the date that a post-test is administered to the evaluation group.

In the metric benchmark level field 541, an initial value of the performance metric, as achieved by a control group, is displayed. This value is obtained at the same time as the evaluation group benchmark level, and is also displayed in the metric trend graph 554 at the bottom right of GUI 500. In the metric post-training level field 542, a final value of the performance metric, as achieved by the control group, is displayed. This value is obtained at the same time as the evaluation group post-training level and is also displayed in the metric trend graph 554 at the bottom right of the GUI 500. The metric group % change field 543 displays the percent change of the performance metric level for the control group over the course of a training project. This value may be automatically calculated and is also displayed in the metric percentage change graph 556 at the bottom right of GUI 500.

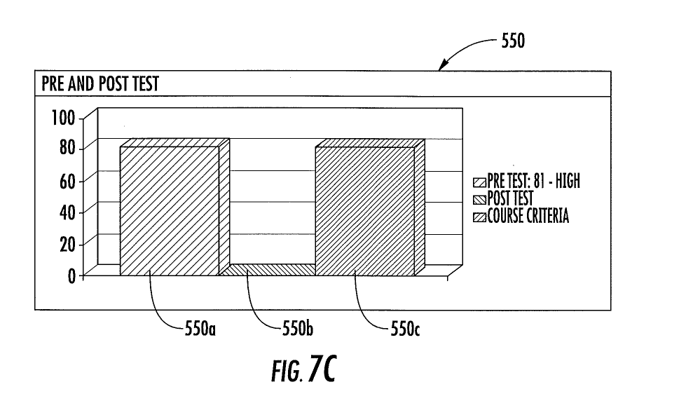

Still referring to the GUI 500 of FIGS. 5A-5B, the various illustrated graphs 550-556 will now be described. The pre- and post-test graph 550 displays the results of classroom training and is displayed once classroom training is completed and the pre-test and post-test scores are entered via GUI 500. Three values are displayed: pre-test results 550a, post-test results 550b and course pass/fail criteria 550c, as illustrated in FIGS. 7A-7C. The pre- and post-test graph 550 illustrates the effectiveness of classroom learning. The height difference in the pre- and post-test values shows how much knowledge was acquired by the evaluation group in the classroom. Additionally, comparison of the post-test and pass values shows if the minimum threshold was achieved. As such, the pre- and post-test graph 550 provides a visual representation of the effectiveness of a training program that is quickly and easily understood by a user.

FIGS. 7A-7C are pre- and post-test graphs 550 that illustrate various scenarios, according to embodiments of the present invention. For example, in FIG. 7A, the illustrated pre- and post-test graph 550 illustrates the desired outcome of a training program. The low pre-test score 550a shows that there is sufficient opportunity for learning to occur. The post-test score 550b shows learning has occurred at a desired level, validating the effectiveness of the classroom training process. In FIG. 7B, the illustrated pre- and post-test graph 550 illustrates that learning did not occur at a satisfactory level and, thus, the training was ineffective. FIG. 7B, thus, suggests that the training content should be reviewed to determine what improvements need to be made. In FIG. 7C, the illustrated pre- and post-test graph 550 illustrates that the evaluation group is already familiar with the training program content. FIG. 7C, thus, suggests that the existing training will be ineffective and that alternative training may be required.

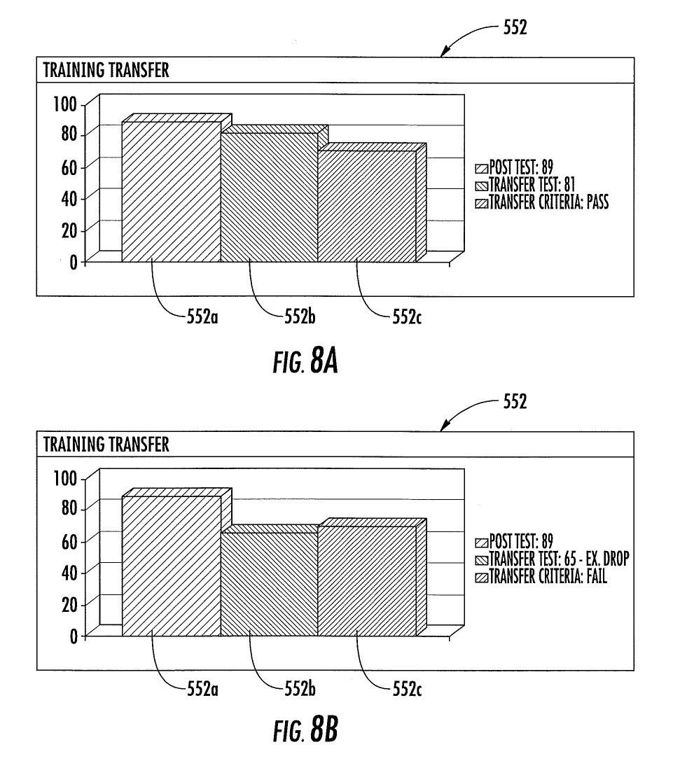

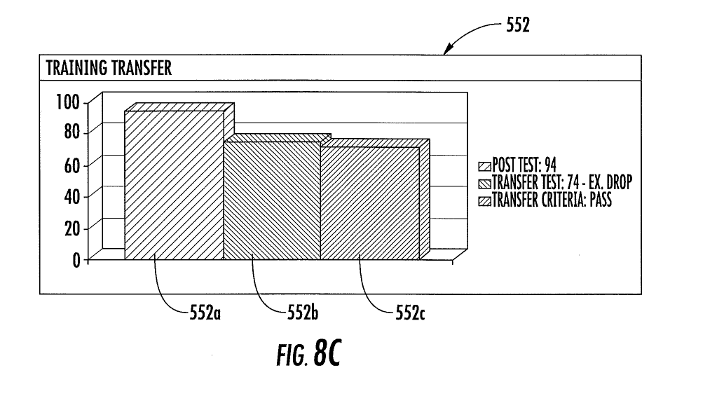

Still referring to the GUI 500 of FIG. 5A, the training transfer graph 552 displays the post-test results and training transfer results in order to provide a comparison of classroom learning and the retention of knowledge after the evaluation group has returned to work in the organization. The training transfer graph 552 is complete after the evaluation group has returned to work in the organization and the training transfer test is administered, scored, and entered into GUI 500. Three values are displayed in the training transfer graph 552: post-test results 552a, training transfer results 552b, and training transfer pass/fail criteria 552c, as illustrated in FIGS. 8A-8C. The training transfer graph 552 illustrates the effectiveness of transferring classroom learning to performance in the organization by the members of the evaluation group. The height difference in the post-test results 552a and training transfer results 552b shows the retention of classroom knowledge after returning to work in the organization. Some drop in this value is normal, yet it should be noted if the difference exceeds the acceptable amount displayed in the acceptable drop field 516 of GUI 500. The height difference between the training transfer Results 552b and the training transfer pass/fail criteria 552c shows if the minimum passing threshold was achieved.

FIGS. 8A-8C are training transfer graphs 552 that illustrate various scenarios. For example, the training transfer graph 552 in FIG. 8A illustrates the desired outcome of transferring classroom learning to work in the organization. Learning occurred in the classroom and the evaluation group has effectively transferred that knowledge to work in the organization. In FIG. 8B, the training transfer graph 552 illustrates insufficient transfer of knowledge to work in the organization. FIG. 8B suggests that a review of causes for the lack of use of new knowledge/skills should be made. In FIG. 8C, the training transfer graph 552 illustrates that knowledge and skills transferred to the work being performed by the evaluation group in the organization, but that some factors may be reducing the effectiveness of the training transfer. FIG. 8C suggests that some improvement in transfer and work performance may be needed.

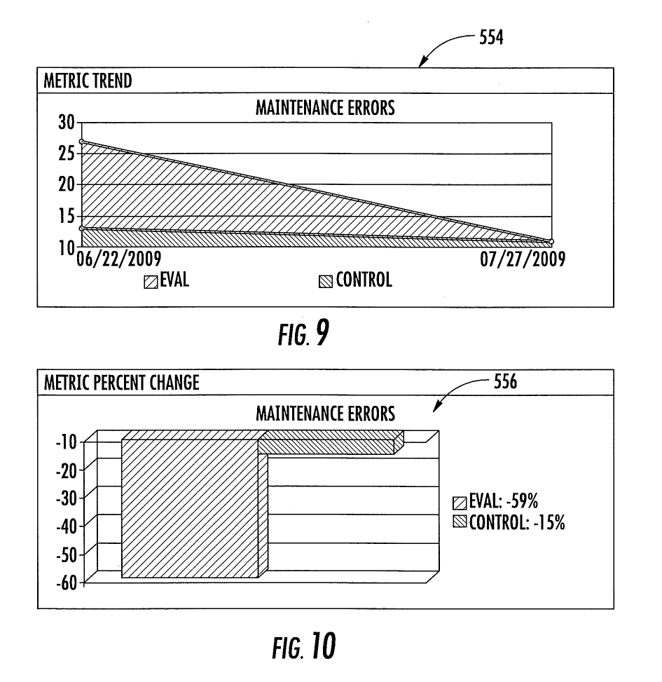

Referring back to the GUI 500 of FIG. 5B, the metric trend graph training transfer graph 554 shows the metric benchmark level (field 534, FIG. 5B) and the metric post training level (field 535, FIG. 5B) for both the evaluation group and the control group. The metric percentage change graph 556 shows the calculated metric group % change values (field 536, FIG. 5B) for both the evaluation group and the control group. The metric trend graph training transfer graph 554 and the metric percentage change graph 556 are complete after the metric post training level is measured and recorded in field 535 of GUI 500 (FIG. 5B) for the evaluation group and the control group. The illustrated metric trend graph 554 in FIG. 9 illustrates a desirable change in performance metric (i.e., a steeper decline in maintenance errors by the evaluation group as compared with the control group). The illustrated metric percent change graph 556 in FIG. 10 illustrates a desirable outcome wherein maintenance errors by the evaluation group have decreased percentage-wise much more than for the control group.

FIG. 11 illustrates a processor 700 and a memory 702 that may be used to implement various operations described above with respect to FIGS. 1A, 1B, 2-6, 7A-7C, 8A-8C, and 9-10, according to some embodiments of the present invention. For example, in some embodiments of the present invention, the processor 700 and memory 702 may be used to embody the processors and the memories used in identifying performance gaps in an organization; determining whether identified performance gaps are addressable with training; selecting, designing and modifying training programs to address identified performance gaps; determining whether learning opportunities exist and whether acceptable levels of learning have occurred in response to training; determining whether behavior change within an organization has occurred as a result of training; and calculating return on investment (ROI) for training.

The processor 700 communicates with the memory 702 via an address/data bus 704. The processor 700 may be, for example, a commercially available or custom microprocessor. The memory 702 is representative of the overall hierarchy of memory devices containing the software and data used to identify performance gaps in an organization, to determine whether identified performance gaps are addressable with training, to select/design/modify training programs to address identified performance gaps, to determine whether learning opportunities exist and whether acceptable levels of learning have occurred in response to training, to determine whether behavior change within an organization has occurred as a result of training, and to calculate the ROI for a training program, in accordance with some embodiments of the present invention. The memory 702 may include, but is not limited to, the following types of devices: cache, ROM, PROM, EPROM, EEPROM, flash, SRAM, and DRAM.

As shown in FIG. 11, the memory 702 may hold six or more major categories of software and data: an operating system 706, a performance gap identification module 708, a training program selection/creation module 710, a learning opportunity quantification module 712, a behavior change determination module 714, an ROI determination module 716, a metric change module 718, an administrative module 720, and a reports module 722. The operating system 706 controls operations of the performance gap identification module 708, training program selection/creation module 710, learning opportunity quantification module 712, behavior change determination module 714, ROI determination module 716, metric change module 718, administrative module 720, and reports module 722.

The performance gap identification module 708 comprises logic for identifying performance gaps for various members of an organization, for identifying knowledge and skills needed to address identified performance gaps, to identify behavior change required to close identified performance gaps, and to determine whether a performance gap is addressable by a training program. The training program selection/creation module 710 comprises logic for selecting and/or creating a training program to address an identified performance gap. The training program selection/creation module 710 comprises logic for selecting various ways to measure progress of an evaluation group during and after a training program and to select the dates for acquiring such measurements. The training program selection/creation module 710 may also comprise logic for identifying/selecting a control group.

The learning opportunity quantification module 712 comprises logic for quantifying an available learning opportunity for an evaluation group, including interpretation of results from pre-tests and post-tests administered to evaluation groups and control groups. The behavior change determination module 714 comprises logic for determining whether the behavior of members of an evaluation group has changed within an organization. The behavior change determination module 714 also comprises logic for determining causes for behavior change failures. The ROI determination module 716 comprises logic for determining the cost of a training program and calculating an ROI for the training program. The metric change module 718 calculates and displays the change in the metric between the benchmark date (prior to training) and the post training date. The change in the metric (typically measured by %) may be an indication of the specified organizational metric being impacted by training. When the percentage change in the metric is translated into a financial figure, this financial figure is used to determine the (gain or loss) and may be used in determining the ROI of training.

The administrative module 720 comprises logic for managing such items as user setup, access control, and project management features including, but not limited to, scheduling, sorting, etc. The reports module 722 comprises logic for generating various reports. Generated reports may include, but are not limited to, reports regarding projects, and data from an individual project or multiple projects.

Although FIG. 11 illustrates an exemplary software architecture that may facilitate correcting performance problems within an organization, it will be understood that the present invention is not limited to such a configuration, but is intended to encompass any configuration capable of carrying out the operations described herein. Computer program code for carrying out operations of the performance gap identification module 708, training program selection/creation module 710, learning opportunity quantification module 712, behavior change determination module 714, ROI determination module 716, metrics change module 718, administrative module 720, and reports module 722 may be written in a high-level programming language, such as Python, Java, C, and/or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller. Embodiments of the present invention are not limited to a particular programming language.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the teachings and advantages of this invention. Accordingly, all such modifications are intended to be included within the scope of this invention as defined in the claims. The invention is defined by the following claims, with equivalents of the claims to be included therein.

That which is claimed is:

1. A method of addressing performance problems within an organization, comprising:
identifying a gap between actual work performance and expected work performance by a group of one or more persons within an organization;
identifying knowledge and/or skills required to reduce the performance gap;
selecting a training program for supplying the group with the identified knowledge and/or skills;
assigning a training date for the group to receive the selected training program;
identifying a measurable performance metric that can reflect behavior change of the group with respect to work performance; and
assigning a behavior change date after the training date on which to measure the performance metric, wherein the behavior change date is selected based on historical data associated with transfer of similar knowledge and/or skills.

2. The method of claim 1, further comprising selecting a provider to administer the training program to the group.

3. The method of claim 1, further comprising determining whether the performance gap can be reduced via training prior to selecting a training program.

4. The method of claim 1, wherein the performance metric is currently monitored by the organization.

5. The method of claim 1, further comprising assigning a benchmark date prior to the training date on which to measure the performance metric for the group.

6. The method of claim 5, further comprising measuring the performance metric for the group on the benchmark date.

7. The method of claim 6, further comprising:
administering a first test to the group on a date prior to the training date, wherein the first test is configured to measure knowledge and/or skills of the group;
administering the training program to the group on the training date; and
administering a second test to the group on a date after the training date and before the behavior change date, wherein the second test is identical to the first test.

8. The method of claim 7, further comprising analyzing results from the first test and determining if a sufficient learning opportunity exists prior to administering the training program.

9. The method of claim 7, further comprising:
comparing an average score obtained by the group on the second test with an average score obtained by the group on the first test; and
in response to determining that the difference between the two average scores is less than a predetermined amount, modifying the training program and administering the modified training program to the group.

10. The method of claim 9, further comprising displaying a visual representation of a comparison of the average scores of the first and second tests.

11. The method of claim 7, further comprising measuring the performance metric with respect to the group on the behavior change date.

12. The method of claim 7, further comprising:
determining the cost associated with administering the training program to the group;
comparing the performance metric measured on the behavior change date with the performance metric measured on the benchmark date; and
determining a return on investment value using the cost associated with administering the training program to the group and a difference between a value of the performance metric on the behavior change date and a value of the performance metric on the benchmark date.

13. The method of claim 1, further comprising:
identifying a second group of one or more persons in the organization that are not in the first group, wherein the second group is homogeneous to the first group;
measuring the performance metric with respect to the second group on the benchmark date;
measuring the performance metric with respect to the first group on the behavior change date; and
comparing the performance metric measured on the behavior change date for the first group with the performance metric measured on the benchmark date for the second group to quantify an amount the performance gap has been reduced.

14. The method of claim 13, further comprising displaying a visual representation of a comparison of the performance metric for the first group measured on the behavior change date and the performance metric measured for the second group on the benchmark date.

15. A method of addressing performance problems within an organization, comprising:
designing a training program to address an identified gap between actual work performance and expected work performance by a group of one or more persons within an organization;
comparing an average score obtained by the group on a first test administered to the group before the group has attended the training program with an average score obtained by the group on a second test administered to the group after the group has attended the training program, wherein the first and second tests are identical and are configured to measure knowledge and/or skills of the group related to expected work performance; and
in response to determining that a difference between the two average scores is less than a predetermined amount, modifying the training program.

16. The method of claim 15, further comprising displaying a visual representation of a comparison of the average scores of the first and second tests.

17. A method of addressing performance problems within an organization, comprising:
designing a training program to address an identified gap between actual work performance and expected work performance by a group of one or more persons within an organization;
measuring a performance metric that reflects a change in behavior of the group with respect to the performance gap after the group has attended the training program;
determining the cost associated with administering the training program to the group; and
determining a return on investment value of the training program.

18. The method of claim 17, further comprising:
identifying a second group of one or more persons in the organization that are not in the first group, wherein the second group is homogeneous to the first group;
measuring the performance metric with respect to the second group; and
comparing the performance metric measured for the first group with the performance metric measured for the second group to quantify an amount the performance gap has been reduced.

19. The method of claim 18, further comprising displaying a visual representation of a comparison of the performance metric measured for the first and second groups.

20. A computer apparatus, comprising a processor configured to:
identify a gap between actual work performance and expected work performance by a group of one or more persons within an organization;
identify knowledge and/or skills required to reduce the performance gap;
select a training program for supplying the group with the identified knowledge and/or skills;
assign a training date for the group to receive the selected training program;
identify a measurable performance metric that can reflect behavior change of the group with respect to work performance; and
assign a behavior change date after the training date on which to measure the performance metric, wherein the behavior change date is selected based on historical data associated with transfer of similar knowledge and/or skills.

21. The computer apparatus of claim 20, wherein the processor is further configured to determine whether the performance gap can be reduced via training prior to selecting a training program.

22. The computer apparatus of claim 20, wherein the processor is further configured to assign a benchmark date prior to the training date on which to measure the performance metric for the group.

23. The computer apparatus of claim 22, wherein the processor is further configured to measure the performance metric for the group on the benchmark date.

24. The computer apparatus of claim 23, wherein the processor is further configured to:
administer a first test to the group on a date prior to the training date, wherein the first test is configured to measure knowledge and/or skills of the group;
administer the training program to the group on the training date; and
administer a second test to the group on a date after the training date and before the behavior change date, wherein the second test is identical to the first test.

25. The computer apparatus of claim 24, wherein the processor is further configured to analyze results from the first test and determine if a sufficient learning opportunity exists prior to administering the training program.

26. The computer apparatus of claim 24, wherein the processor is further configured to:
compare an average score obtained by the group on the second test with an average score obtained by the group on the first test; and
in response to determining that the difference between the two average scores is less than a predetermined amount, modify the training program and administering the modified training program to the group.

27. The computer apparatus of claim 26, wherein the processor is further configured to display a visual representation of a comparison of the average scores of the first and second tests.

28. The computer apparatus of claim 24, wherein the processor is further configured to:
determine the cost associated with administering the training program to the group;
compare the performance metric measured on the behavior change date with the performance metric measured on the benchmark date; and
determine a return on investment value using the cost associated with administering the training program to the group and a difference between a value of the performance metric on the behavior change date and a value of the performance metric on the benchmark date.

29. The computer apparatus of claim 20, wherein the processor is further configured to:
identify a second group of one or more persons in the organization that are not in the first group, wherein the second group is homogeneous to the first group;
measure the performance metric with respect to the second group on the benchmark date;
measure the performance metric with respect to the first group on the behavior change date; and
compare the performance metric measured on the behavior change date for the first group with the performance metric measured on the benchmark date for the second group to quantify an amount the performance gap has been reduced.

30. The computer apparatus of claim 29, wherein the processor is further configured to display a visual representation of a comparison of the performance metric for the first group measured on the behavior change date and the performance metric measured for the second group on the benchmark date.

31. A computer apparatus of addressing performance problems within an organization, comprising a processor configured to:
design a training program to address an identified gap between actual work performance and expected work performance by a group of one or more persons within an organization;
compare an average score obtained by the group on a first test administered to the group before the group has attended the training program with an average score obtained by the group on a second test administered to the group after the group has attended the training program, wherein the first and second tests are identical and are configured to measure knowledge and/or skills of the group related to expected work performance; and
in response to determining that a difference between the two average scores is less than a predetermined amount, modify the training program.

32. The computer apparatus of claim 31, wherein the processor is further configured to display a visual representation of a comparison of the average scores of the first and second tests.

33. A computer apparatus of addressing performance problems within an organization, comprising a processor configured to:
design a training program to address an identified gap between actual work performance and expected work performance by a group of one or more persons within an organization;
measure a performance metric that reflects a change in behavior of the group with respect to the performance gap after the group has attended the training program;
determine the cost associated with administering the training program to the group; and
determine a return on investment value of the training program.

34. The computer apparatus of claim 33, wherein the processor is further configured to:
identify a second group of one or more persons in the organization that are not in the first group, wherein the second group is homogeneous to the first group;
measure the performance metric with respect to the second group; and
compare the performance metric measured for the first group with the performance metric measured for the second group to quantify an amount the performance gap has been reduced.

35. The computer apparatus of claim 34, wherein the processor is further configured to display a visual representation of a comparison of the performance metric measured for the first and second groups.

36. An article of manufacture for addressing performance problems within an organization, comprising a computer readable storage medium having encoded thereon instructions that, when executed on a computer, cause the computer to:
identify a gap between actual work performance and expected work performance by a group of one or more persons within an organization;
identify knowledge and/or skills required to reduce the performance gap;
select a training program for supplying the group with the identified knowledge and/or skills;
assign a training date for the group to receive the selected training program;
identify a measurable performance metric that can reflect behavior change of the group with respect to work performance; and
assign a behavior change date after the training date on which to measure the performance metric, wherein the behavior change date is selected based on historical data associated with transfer of similar knowledge and/or skills.

37. The article of manufacture of claim 36, wherein the computer readable storage medium has encoded thereon instructions that, when executed on a computer, causes the computer to determine whether the performance gap can be reduced via training prior to selecting a training program.

38. The article of manufacture of claim 36, wherein the computer readable storage medium has encoded thereon instructions that, when executed on a computer, causes the computer to assign a benchmark date prior to the training date on which to measure the performance metric for the group.

39. The article of manufacture of claim 38, wherein the computer readable storage medium has encoded thereon instructions that, when executed on a computer, causes the computer to measure the performance metric for the group on the benchmark date.

40. The article of manufacture of claim 39, wherein the computer readable storage medium has encoded thereon instructions that, when executed on a computer, causes the computer to:
administer a first test to the group on a date prior to the training date, wherein the first test is configured to measure knowledge and/or skills of the group;
administer the training program to the group on the training date; and
administer a second test to the group on a date after the training date and before the behavior change date, wherein the second test is identical to the first test.

41. The article of manufacture of claim 40, wherein the computer readable storage medium has encoded thereon instructions that, when executed on a computer, causes the computer to analyze results from the first test and determine if a sufficient learning opportunity exists prior to administering the training program.

42. The article of manufacture of claim 40, wherein the computer readable storage medium has encoded thereon instructions that, when executed on a computer, causes the computer to:
compare an average score obtained by the group on the second test with an average score obtained by the group on the first test; and
in response to determining that the difference between the two average scores is less than a predetermined amount, modify the training program and administering the modified training program to the group.

43. The article of manufacture of claim 42, wherein the computer readable storage medium has encoded thereon instructions that, when executed on a computer, causes the computer to display a visual representation of a comparison of the average scores of the first and second tests.

44. The article of manufacture of claim 40, wherein the computer readable storage medium has encoded thereon instructions that, when executed on a computer, causes the computer to:
determine the cost associated with administering the training program to the group;
compare the performance metric measured on the behavior change date with the performance metric measured on the benchmark date; and
determine a return on investment value using the cost associated with administering the training program to the group and a difference between a value of the performance metric on the behavior change date and a value of the performance metric on the benchmark date.

45. The article of manufacture of claim 36, wherein the computer readable storage medium has encoded thereon instructions that, when executed on a computer, causes the computer to:
identify a second group of one or more persons in the organization that are not in the first group, wherein the second group is homogeneous to the first group;
measure the performance metric with respect to the second group on the benchmark date;
measure the performance metric with respect to the first group on the behavior change date; and
compare the performance metric measured on the behavior change date for the first group with the performance metric measured on the benchmark date for the second group to quantify an amount the performance gap has been reduced.

46. The article of manufacture of claim 45, wherein the computer readable storage medium has encoded thereon instructions that, when executed on a computer, causes the computer to display a visual representation of a comparison of the performance metric for the first group measured on the behavior change date and the performance metric measured for the second group on the benchmark date.

47. An article of manufacture for addressing performance problems within an organization, comprising a computer readable storage medium having encoded thereon instructions that, when executed on a computer, cause the computer to:
design a training program to address an identified gap between actual work performance and expected work performance by a group of one or more persons within an organization;
compare an average score obtained by the group on a first test administered to the group before the group has attended the training program with an average score obtained by the group on a second test administered to the group after the group has attended the training program, wherein the first and second tests are identical and are configured to measure knowledge and/or skills of the group related to expected work performance; and
in response to determining that a difference between the two average scores is less than a predetermined amount, modify the training program.

48. The article of manufacture of claim 47, wherein the computer readable storage medium has encoded thereon instructions that, when executed on a computer, causes the computer to display a visual representation of a comparison of the average scores of the first and second tests.

49. An article of manufacture for addressing performance problems within an organization, comprising a computer readable storage medium having encoded thereon instructions that, when executed on a computer, cause the computer to:
design a training program to address an identified gap between actual work performance and expected work performance by a group of one or more persons within an organization;
measure a performance metric that reflects a change in behavior of the group with respect to the performance gap after the group has attended the training program;
determine the cost associated with administering the training program to the group; and
determine a return on investment value of the training program.

50. The article of manufacture of claim 49, wherein the computer readable storage medium has encoded thereon instructions that, when executed on a computer, causes the computer to:
identify a second group of one or more persons in the organization that are not in the first group, wherein the second group is homogeneous to the first group;
measure the performance metric with respect to the second group; and
compare the performance metric measured for the first group with the performance metric measured for the second group to quantify an amount the performance gap has been reduced.

51. The article of manufacture of claim 50, wherein the computer readable storage medium has encoded thereon instructions that, when executed on a computer, causes the computer to display a visual representation of a comparison of the performance metric measured for the first and second groups.
